(19) United States
(12) Patent Application Publication
(10) Pub. No.: US 2025/0110762 A1
(43) Pub. Date: Apr. 3, 2025

(54) MEASUREMENT CONTROL DEVICE

(71) Applicant: MITUTOYO CORPORATION, Kawasaki-shi (JP)

(72) Inventors: Ryoichi Imaizumi, Tokyo (JP); Makoto Kaieda, Miyazaki (JP)

(21) Appl. No.: 18/899,786

(22) Filed: Sep. 27, 2024

(30) Foreign Application Priority Data
Oct. 2, 2023 (JP) 2023-171397

(51) Int. Cl. G06F 9/451; G06F 3/04817

(52) U.S. Cl. CPC G06F 9/453; G06F 3/04817

(57) ABSTRACT

A measurement control device includes a screen interface and controls a measurement operation of a measurement machine through the screen interface, the measurement control device including: a normal display screen that forms a part of the screen interface; one or more functional components provided on the normal display screen; a help mode button provided on a part of the normal display screen to switch a normal display mode from/to a help display mode; one or more help icons displayed on the normal display screen in the help display mode in a manner each associated with corresponding one of the functional components; a summary description field displayed on a part of the normal display screen when one of the help icons is selected; a detail display button displayed on a part of the summary description field; and a detailed description field displayed when the detail display button is selected.

### CROSS REFERENCE TO RELATED APPLICATIONS

The entire disclosure of Japanese Patent Application No. 2023-171397 filed Oct. 2, 2023 is expressly incorporated by reference herein.

### TECHNICAL FIELD

The present invention relates to a measurement control device.

### BACKGROUND ART

A screen interface is used in a measurement control device for controlling an operation of a measurement machine. For instance, a measurement control device in a form of a computer system is connected to a coordinate measuring machine, and the coordinate measuring machine can be operated by a user through the screen interface (see Literature 1: JP 2015-118097 A).

The screen interface is provided with a help function for assisting the user.

The help function is sometimes implemented by displaying a help file in a separate window superposed on an operation screen and following link(s) in a table of contents of the help file to access a description for a desired item (see Literature 2: JP 2010-96674 A). The help file displayed in the separate window is a simplified version of the description in an operation manual or an on-line manual showing the operation manual itself.

The help function is alternatively implemented by identifying an item currently selected and displaying the description for the selected item in a comment field on the operation screen (see Literature 3: JP 2009-204553 A). The comment field is a display section fixedly allocated at a part of the operation screen or a balloon comment floating near an item pointed by a pointer on the operation screen.

The above-described help function, which contributes in enhancement in the operability of the measurement control device to some extent, still requires improvement in visibility of the operation screen and operation efficiency for obtaining help information on a desired item.

For instance, when there are a large number of functional components (e.g. operation buttons and display fields for numerical values) on the operation screen, complicated operations are necessary in order to reach the desired item in a method of displaying a table of contents.

It is conceivable to provide a help mode button near each functional component on the operation screen in order to obtain the help information related to that functional component. However, when there are a large number of the functional components on the operation screen, the number of the help mode buttons is correspondingly increased, thereby complicating the operation screen.

In contrast, in a method of automatically displaying the help information in the comment field, a size of the comment field, which occupies a part of the operation screen, is difficult to be enlarged, so that sufficient help information cannot be displayed. Specifically, detailed description cannot be provided by a brief help comment, whereas displaying the operation manual itself requires complicated operations for reading the manual and following the link(s) in the table of contents.

### SUMMARY OF THE INVENTION

An object of the invention is to provide a measurement control device having a help function capable of providing sufficient amount of information with a simple operation and screen.

A measurement control device according to an aspect of the invention includes a screen interface and is configured to control a measurement operation of a measurement machine through the screen interface, the measurement control device including: a normal display screen that forms a part of the screen interface; one or more functional components provided on the normal display screen; a help mode button provided on a part of the normal display screen and configured to switch a normal display mode from/to a help display mode; one or more help icons displayed on the normal display screen in the help display mode, the help icons being each associated with corresponding one of the functional components; a summary description field and a detail display button displayed on a part of the normal display screen when one of the help icons is selected; and a detailed description field displayed when the detail display button is selected.

According to the above aspect of the invention, when the help mode button is operated to switch the current mode to the normal display mode, only the functional components necessary for the operation screen can be displayed on the normal display screen with only the help mode button as the help function. According to the normal display mode, the screen can be simplified. Further, the help mode button may also be omitted by using a specific operation command for changing the display mode.

In contrast, when the help mode button is operated to change the current mode to the help display mode, the help icons each associated with corresponding one of the functional components are displayed on the normal display screen. By selecting one of the help icons, the summary description field is displayed on a part of the normal display screen. Each of the help icons is displayed in a manner associated with corresponding one of the functional components, and therefore at a point in time when one of the help icons is selected, a target functional component related to the selected one of the help icons is unambiguously determined, so that summarized description (e.g. a brief help comment) of the target functional component can be immediately displayed without following links in the table of contents or the like.

Further, when the detail display button displayed together with the summary description field is selected, the detailed description field is displayed to provide a detailed description on the pre-selected one of the functional components. The detailed description field is displayed in a separate window superposed on the normal display screen or in a section partitioned in a part of the normal display screen, and thereby the detailed description field can display the detailed description in a sufficiently large area. With the use of the two-stage structure of the description fields, i.e., the summary description field and the detailed description field, the help function can be efficiently provided by a simple description in the summary description field and sufficient amount of information for the help function can be provided by the detailed description (e.g. corresponding description in the operation manual) in the detailed description field.

In the measurement control device according to the above aspect of the invention, it is preferable that the summary description field is a comment area provided at a lowermost section of the normal display screen.

According to an arrangement described above, the help comment can be displayed without interfering with the other components displayed on the normal display screen. In addition, the process can be simplified as compared with displaying the help comment in a separate window or the like.

In the measurement control device according to the above aspect of the invention, it is preferable that the detail display button is displayed on a part of the summary description field.

According to an arrangement described above, when the help comment displayed in the summary display field is insufficient, it is possible to display the detailed description field by immediately operating the detail display button from the summary display field.

In the measurement control device according to the above aspect of the invention, it is preferable that the detailed description field is configured to display a description, in an on-line manual of the measurement control device, on one of the functional components associated with selected one of the help icons.

According to an arrangement described above, the description in the on-line operation manual of the measurement control device is displayed, so that sufficient amount of information for the help function can be provided. Further, the description of the operation manual can be displayed without following the links in the table of contents, thereby achieving an easy and efficient operation.

In the measurement control device according to the above aspect of the invention, it is preferable that a manual display button configured to display a table of contents page of the on-line manual is provided at a part of the normal display screen.

According to an arrangement described above, the table of contents page can be immediately opened when the on-line operation manual of the measurement control device is to be independently or systematically checked.

In the measurement control device according to the above aspect of the invention, it is preferable that the normal display screen includes a basic screen and a developed screen transitioned from or superposed on the basic screen, the help mode button is provided at least on the basic screen, and the help icons are each displayed on corresponding one of the functional components on the basic screen and on corresponding one of the functional components on the developed screen in the help display mode.

According to an arrangement described above, when the help display mode is selected on the basic screen, the help display mode is kept also on the developed screen in a separate window independent from the basic screen and the help icons can be each displayed for corresponding one of the functional components.

According to the above aspect(s) of the invention, a measurement control device having a help function capable of providing sufficient amount of information with a simple operation and screen can be provided.

### BRIEF DESCRIPTION OF DRAWINGS

FIG. 1 is a view illustrating a measurement control device according to an exemplary embodiment of the invention.

FIG. 2 is a block diagram illustrating a functional arrangement of the measurement control device according to the exemplary embodiment.

FIG. 3 is a view illustrating a normal display screen according to the exemplary embodiment.

FIG. 4 is a view illustrating a help display screen according to the exemplary embodiment.

FIG. 5 is a view illustrating a screen in which a help comment is displayed in the exemplary embodiment.

FIG. 6 is a view illustrating a screen in which an on-line manual is displayed in the exemplary embodiment.

FIG. 7 is a view illustrating a screen in which help icons are displayed in a developed screen in the exemplary embodiment.

FIG. 8 is a flowchart illustrating a process in the measurement control device according to the exemplary embodiment.

### DETAILED DESCRIPTION

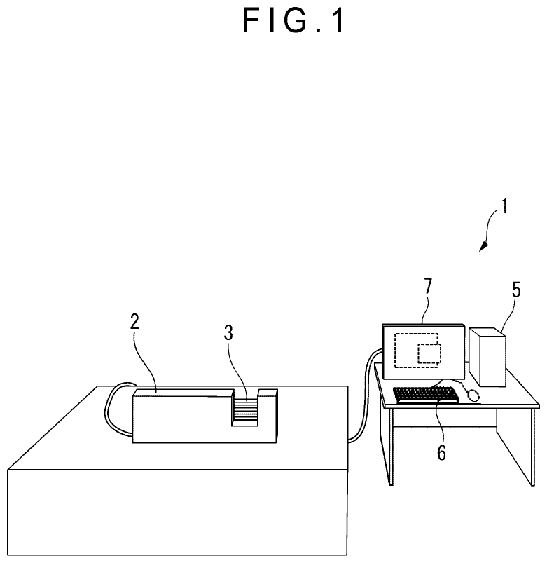

FIG. 1 illustrates a measurement system including a measurement control device 1 according to an exemplary embodiment of the invention.

An example of a measuring machine 2 is an existing laser scan micrometer, which is configured to measure a width of a workpiece placed in a parallel laser beam 3. The measuring machine 2 may be a different type of a measuring machine such as a coordinate measuring machine and a surface profile measuring machine.

The measurement control device 1 includes a processor 5 provided by a computer system configured to load and run a program, an operation device 6 including a keyboard and/or a pointing device operable by a user, and a display device 7 such as a display panel visible to the user.

The processor 5 is configured to run a predetermined measurement program, thereby causing the measuring machine 2 to perform a predetermined measurement operation and measure the width of the workpiece. At the time of measurement, the processor 5 causes the display device 7 to display a screen interface to receive a user's operation through the operation device 6. Current status, set values, measurement values, and the like of the processor 5 and measuring machine 2 are displayed on the screen interface.

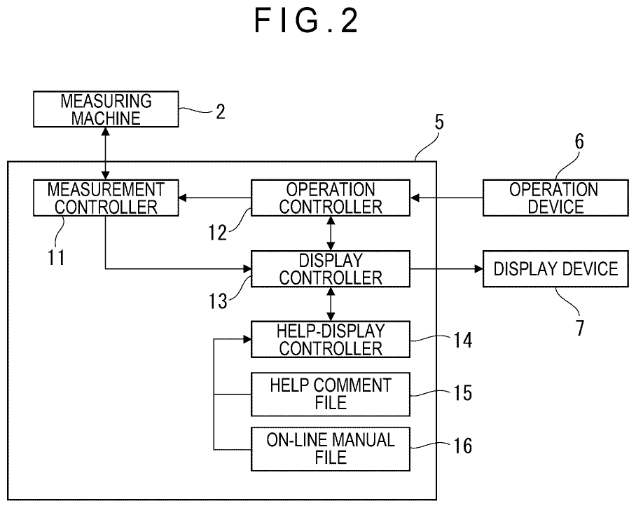

FIG. 2 illustrates functional components relating to the screen interface of the measurement control device 1. The functional components are deployed in the processor 5 by running a software imported to the processor 5.

The processor 5 includes a measurement controller 11, an operation controller 12, a display controller 13, and a help-display controller 14.

The measurement controller 11 is configured to run a designated measurement program to control the measuring machine 2 to perform a predetermined operation.

The operation controller 12 is configured to receive the user's operation through the operation device 6 and perform a process, in accordance with the received operation, on the measurement controller 11. Examples of the operation include selecting a measurement operation, starting/ending the measurement operation, processing and displaying measurement results, setting and adjusting process parameters, and the like.

The display controller 13 is a controller for displaying an image serving as the screen interface on the display device 7, and is configured to receive the user's operation through the operation device 6 to reflect the user's operation on the screen interface, and display the status and measurement results of the measuring machine 2 received from the measurement controller 11 on the screen interface.

The help-display controller 14 is a controller for adding the help function on the screen interface, and is connected to a help comment file 15 and an on-line manual file 16 relating to the measurement control device 1. An example of the on-line manual file 16 is an electronic file of an operation manual (user's manual) of the measurement control device 1 in a form of a hypertext provided with link(s) at relating part(s).

A mode of the screen interface is alternately switched between a normal display mode and a help display mode by the processor 5. The current display mode is stored as a flag in a storage area of the processor 5.

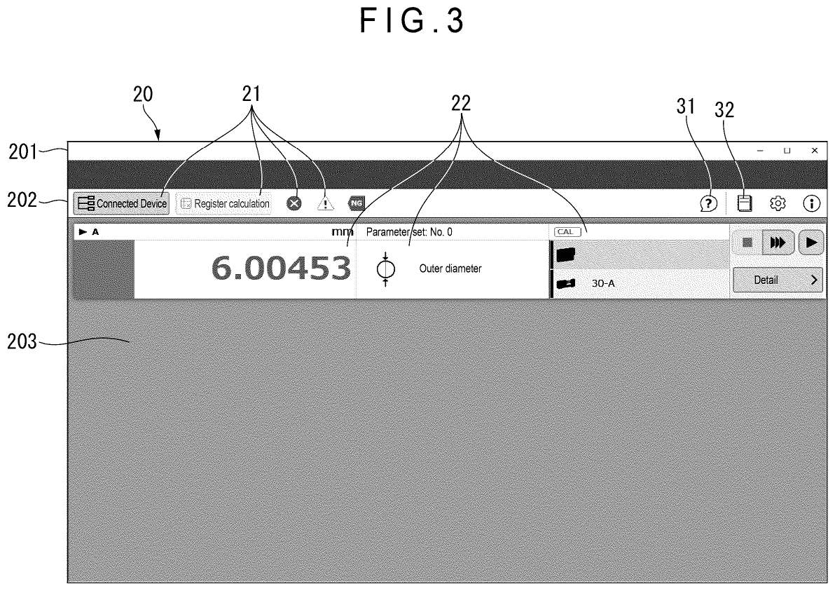

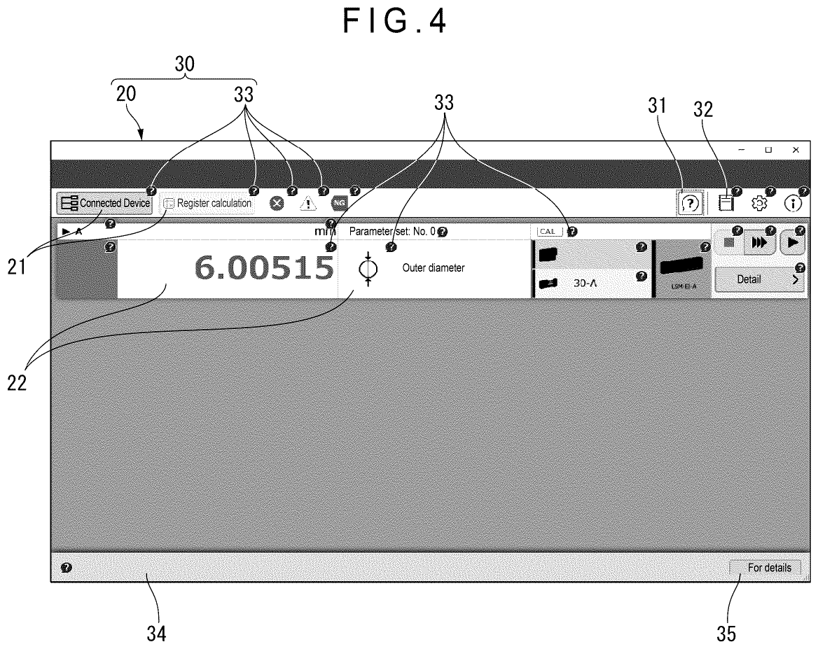

A normal display screen 20 (FIG. 3) and a help display screen 30 (FIGS. 4 to 7) to be displayed as the screen interface on the display device 7 will be described below.

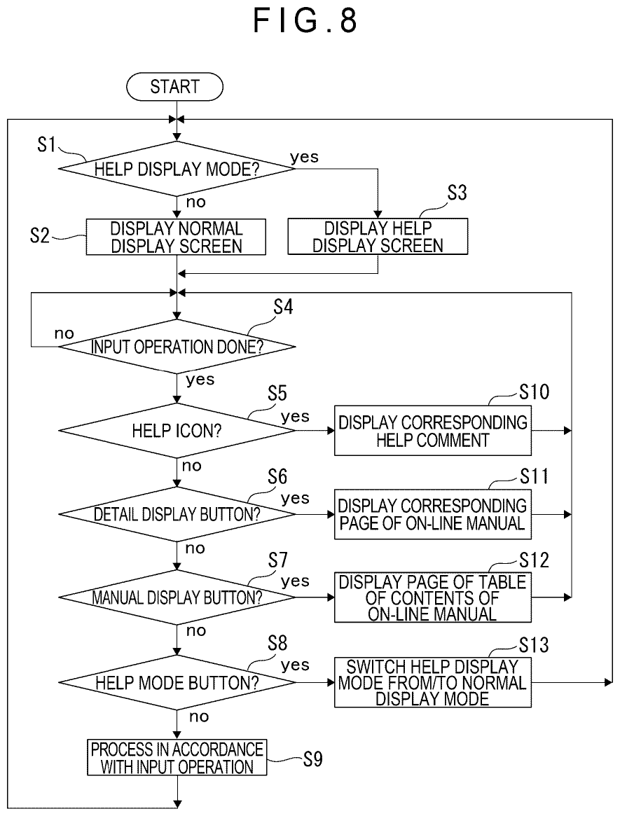

A process flow relating to the help function on the screen interface of the measurement control device 1 will be described later with reference to FIG. 8.

FIG. 3 illustrates an example of the normal display screen 20 to be displayed on the display device 7 in the normal display mode.

In FIG. 3, the normal display screen 20 is provided using the window system of an operating system of the processor 5, and has a basic structure including a title bar 201 and a menu bar 202 at an upper part and a display area 203 provided below the title bar 201 and the menu bar 202.

As functional components, a plurality of function buttons 21 for functions selectable by a user and a plurality of display frames 22 for set values and measurement values are provided in the menu bar 202 and the display area 203 on the normal display screen 20. The functional components may be components that are operated or displayed in a manner different from those described above.

The above-described normal display screen 20 can be displayed by means of the display controller 13 illustrated in FIG. 2.

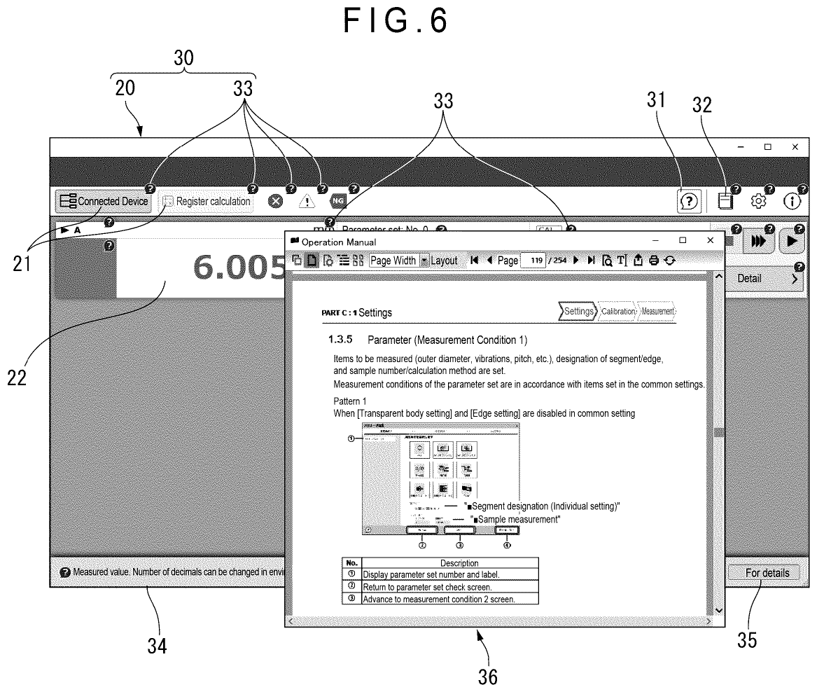

As additional functional components relating to the help function, a help mode button 31 and a manual display button 32 are provided in the menu bar 202. Though detailed later, the normal display mode and the help display mode are alternately switched by pressing the help mode button 31, and thereby switching between ON and OFF of the help function on the screen interface is performed. In addition, the on-line manual of the measurement control device 1 is displayed on the screen (see FIG. 6) by pressing the manual display button 32.

The functions of the help mode button 31 and the manual display button 32 are performed by the help-display controller 14 illustrated in FIG. 2.

FIGS. 4 to 6 each illustrate an example of the help display screen 30 to be displayed on the display device 7 during the help display mode.

The help display screen 30 illustrated in FIG. 4 is displayed when a user presses the help mode button 31 on the normal display screen 20 illustrated in FIG. 3.

In the help display screen 30 illustrated in FIG. 4, a plurality of help icons 33 are superposed on the above-described normal display screen 20.

The help icons 33 are each positioned in the vicinity of, e.g. at an upper right corner of, corresponding one of the function buttons 21 and the display frames 22 that require the help function. The help icons 33 are small-sized icons so that an area of the function buttons 21, the display frames 22, and the other displays of the normal display screen 20 hidden by the help icons 33 is minimized.

On the help display screen 30, a comment area 34 (a summary description field of the invention) is provided at the lowermost section of the normal display screen 20. A detail display button 35 is provided at an end of the comment area 34.

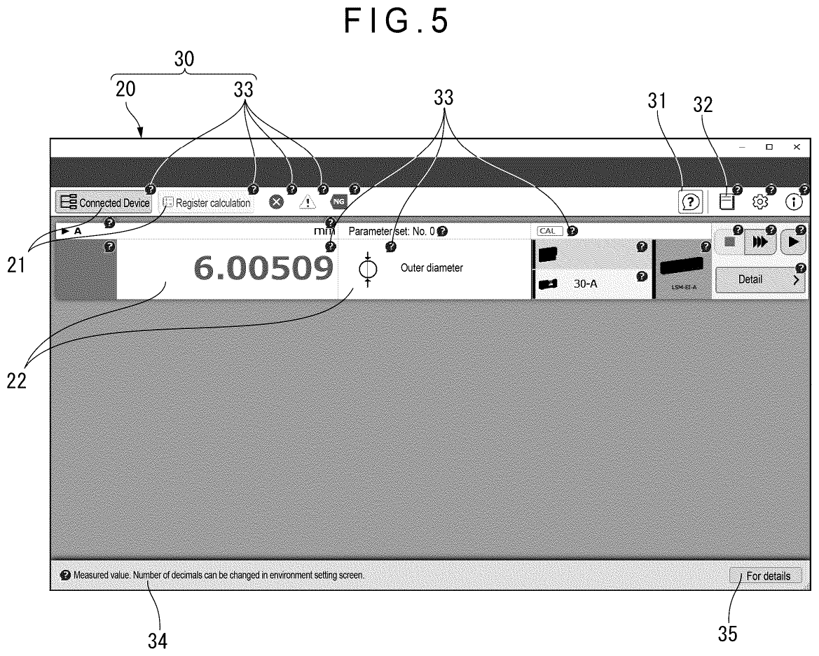

The help display screen 30 illustrated in FIG. 4 is switched to the help display screen 30 illustrated in FIG. 5 when a user presses one of the help icons 33.

In the comment area 34 illustrated in FIG. 5, a help comment for one of the functional components selected by the user, i.e., one of the function buttons 21 or the display frames 22 near the one of the help icons 33 pressed by the user, is displayed.

The help comment is displayed, by the help-display controller 14 of FIG. 2 acquiring the comment relating to one of the functional components selected by the user from the help comment file 15, and displaying the comment in the comment area 34.

When the detail display button 35 in the comment area 34, in which the comment is displayed on the help display screen 30 of FIG. 5, is pressed by a user, an on-line manual 36 is displayed in a separate window (a detailed description field according to the invention) on the help display screen 30 as illustrated in FIG. 6.

In FIG. 6, the on-line manual 36 displayed in the separate window shows a page of description on one of the functional components relating to the comment displayed in the comment area 34, i.e., the one of the functional components selected by the user on the help display screen 30 illustrated in FIG. 4.

The on-line manual 36 is displayed, by the help-display controller 14 of FIG. 2 acquiring the page related to the one of the functional components selected by the user from the on-line manual file 16, and displaying the page in the separate window.

The above-described help function, i.e., the help icons 33, the comment area 34, and the detail display button 35, is kept being enabled also while the separate window is opened by selecting one of the functional components on the normal display screen 20 illustrated in FIG. 3.

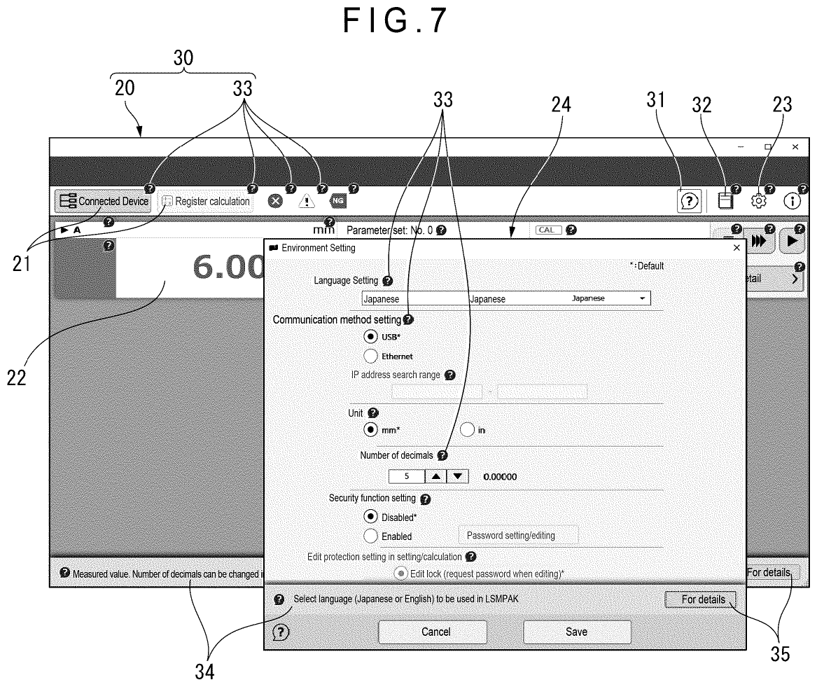

In FIG. 7, an environment setting button 23 is provided, as one of the functional components, on the normal display screen 20 (a basic screen of the invention). When a user presses the environment setting button 23, an environment setting dialog 24 (a developed screen of the invention) is opened in a separate window.

When a user presses the help mode button 31 while the help icons 33 are not displayed in the normal display mode and the environment setting dialog 24 is superposed on the normal display screen 20, the help icons 33, the comment area 34, and the detail display button 35 are each displayed on corresponding one of the functional components on the normal display screen 20 and the functional components in the environment setting dialog 24. The user can use the help function (displaying the help comment or the on-line manual) on the desired one of the functional components on the normal display screen 20 and the environment setting dialog 24 with the use of the help icons 33, the comment area 34, and the detail display button 35.

In contrast, the environment setting dialog 24 may be opened in a separate window when a user presses the environment setting button 23 while the help icons 33 are displayed in the help display mode (the help display screen 30 illustrated in FIG. 4). Being in the help display mode, the help icons 33, the comment area 34, and the detail display button 35 are immediately displayed in the newly opened environment setting dialog 24, thereby allowing the user to use the help function for the functional components in the environment setting dialog 24.

FIG. 8 illustrates an example of a process flow relating to the help function for the screen interface of the measurement control device 1.

As illustrated in FIG. 8, the processor 5 repeats Steps S1 to S4 to stand by for an input operation on the operation device 6.

Once starting the operation, the processor 5 judges whether the current mode is the help display mode (Step S1), displays the normal display screen 20 when it is judged that the current mode is the normal display mode (Step S2), displays the help display screen 30 when the current mode is the help display mode (Step S3), and stands by for the input operation (Step S4).

When the input operation is detected in Step S4, the processor 5 sequentially performs Steps S5 to S8 to judge whether the input operation relates to the help function.

In Steps S5 to S8, when it is judged that the input operation does not relate to the help function, the processor 5 performs a process in accordance with the input operation (Step S9) and then the process flow returns to Step S1.

When it is judged in Steps S5 to S8 that the input operation relates to the help function, the processor 5 performs a corresponding process in accordance with the input operation in each of Steps S5 to S8.

When it is judged in Step S5 that one of the help icons 33 displayed in the help display mode is pressed, the processor 5 identifies one of the functional components associated with the pressed one of the help icons 33, acquires a corresponding help comment from the help comment file 15 to display the corresponding help comment in the comment area 34 (Step S10, see FIG. 5), and again stands by for the input operation (Step S4). It is possible for a user to make another input operation to command a desired process or display a different help comment by pressing another one of the help icons 33.

When it is judged in Step S6 that the detail display button 35 displayed in the help display mode is pressed, the processor 5 identifies one of the functional components associated with the pressed one of the help icons 33, acquires a corresponding description page from the on-line manual file 16 to display the corresponding description page in a separate window (Step S11, see the on-line manual 36 in FIG. 6) and again stands by for the input operation (Step S4.) The user can see other description page(s) through additional input operation(s).

When it is judged in Step S7 that the manual display button 32 is pressed, the processor 5 acquires a table of contents page from the on-line manual file 16, displays the table of contents page in a separate window (Step S12), and again stands by for the input operation (Step S4). The user can access the description page on desired one of the functional components by following the links in the table of contents page through additional input operation(s).

When it is judged in Step S8 that the help mode button 31 is pressed, the processor 5 switches the current mode between the help display mode and the normal display mode (Step S13). Specifically, when the current mode is the normal display mode, the current mode is changed to the help display mode, and when the current mode is the help display mode, the current mode is changed to the normal display mode. In either case, the process flow returns to Step S1, where the screen is displayed in the switched mode (Step S2 or Step S3).

According to the exemplary embodiment as described above, when the help mode button 31 is operated to switch the current mode to the normal display mode, only the functional components (i.e. the function buttons 21 and the display frames 22) necessary for the operation screen can be displayed on the normal display screen 20 with only the help mode button 31 as the help function. According to the normal display mode, the screen can be simplified. It should be noted that the help mode button 31 may also be omitted by using a specific operation command for changing the display mode.

In contrast, when the help mode button 31 is operated to change the current mode to the help display mode, the help icons 33 each associated with corresponding one of the functional components are displayed on the normal display screen 20. When a user selects one of the help icons 33, the summary description field (i.e. the comment area 34) is displayed on a part of the normal display screen 20. Each of the help icons 33 is displayed in a manner associated with corresponding one of the functional components, and therefore at a point in time when one of the help icons 33 is selected, a target functional component related to the selected one of the help icons 33 is unambiguously determined, so that summarized description (help comment) of the target functional component can be immediately displayed without following link(s) in the table of contents or the like.

In addition, by selecting the detail display button 35 displayed together with the summary description field (the comment area 34), the detailed description field (the on-line manual 36 in a separate window) can be displayed to provide a detailed description (a corresponding description page of the on-line manual) on the pre-selected one of the functional components. With the use of the two-stage structure of the description fields, i.e., the summary description field and the detailed description field, the help function can be efficiently provided by a simple description in the summary description field and sufficient amount of information for the help function can be provided by the detailed description in the detailed description field.

In the exemplary embodiment, the comment area 34 provided at the lowermost section of the normal display screen 20 is used as the summary description field. Accordingly, the help comment can be displayed without interfering with other components displayed on the normal display screen 20. In addition, the process can be simplified as compared with displaying the help comment in a separate window or the like.

According to the exemplary embodiment, the detail display button 35 is displayed on a part of the summary display field (the comment area 34). Accordingly, when the help comment displayed in the summary display field is insufficient, it is possible to display the detailed description field (the on-line manual 36) by immediately operating the detail display button 35 from the summary display field.

In the exemplary embodiment, the detailed description field displays the description, in the on-line manual file 16 of the measurement control device 1, on one of the functional components associated with one of the help icons 33 selected by a user. Accordingly, sufficient amount of information for the help function can be provided. Further, the description of the operation manual can be displayed without following the links in the table of contents, thereby achieving an easy and efficient operation.

In the exemplary embodiment, the manual display button 32 for displaying the table of contents page of the on-line manual file 16 is provided on a part of the normal display screen 20. Accordingly, the table of contents page can be immediately opened when the on-line operation manual of the measurement control device 1 is to be independently or systematically checked.

In the exemplary embodiment, the normal display screen 20 includes the basic screen illustrated in FIG. 3 and the developed screen (e.g. the environment setting dialog 24 illustrated in FIG. 7) superposed on the basic screen, where the help mode button 31 is provided at least on the basic screen, and the help icons 33 are displayed in the help display mode on both of the functional components on the basic screen (i.e. on the normal display screen 20) and the functional components on the developed screen (e.g. the environment setting dialog 24). Accordingly, when the help display mode is selected on the basic screen, the help display mode is kept also on the developed screen in a separate window independent from the basic screen and the help icons 33 can be each displayed for corresponding one of the functional components.

It should be noted that the invention is not limited to the above-described exemplary embodiment but includes modifications and the like as long as such modifications and the like are compatible with an object of the invention.

Although the summary description field is the comment area 34 provided at the lowermost section of the normal display screen 20 in the above exemplary embodiment, the summary description field may be provided at another position or, alternatively, needs not be fixedly provided, and for instance, may be a floating component such as a balloon bubbling from corresponding one of the help icons 33.

Further, the detail display button 35 is not necessarily provided at a part of the summary description field but may be provided on the menu bar 202 (see FIG. 3) on the normal display screen 20. For instance, the manual display button 32 on the normal display screen 20 may be configured so that the table of contents page of the on-line manual is displayed when the manual display button 32 is pressed in the normal display mode, and a page corresponding to one of the functional components whose help comment is currently displayed is acquired from the on-line manual to be immediately displayed when the manual display button 32 is pressed in the help display mode.

Although the on-line manual 36 is displayed, as the detailed description field, in a separate window superposed on the normal display screen 20 in the above exemplary embodiment, the on-line manual 36 may be displayed in a section partitioned at a part of the normal display screen 20. It should however be noted that the use of the separate window is suitable in that the detailed description can be provided in a sufficient display area.

Although examples of the normal display screen 20 and the help display screen 30 are described in the above exemplary embodiment, displayed functional components (i.e. the function buttons 21 and the display frames 22) may be on screen(s) of the other status and can be altered as needed in terms of form and contents in accordance with the nature of the measurement control device 1 and/or the measuring machine 2 to be controlled.

Although the measuring machine 2 to be controlled by the measurement control device 1 is a laser scan micrometer in the above exemplary embodiment, the measuring machine 2 may be a coordinate measuring machine or a surface profile measuring machine, another measurement machine or an optical measurement machine to be controlled, or the like.

What is claimed is:

1. A measurement control device comprising a screen interface and configured to control a measurement operation of a measurement machine through the screen interface, the measurement control device comprising:
a normal display screen that forms a part of the screen interface;
one or more functional components provided on the normal display screen;
a help mode button provided on a part of the normal display screen and configured to switch a normal display mode from/to a help display mode;
one or more help icons displayed on the normal display screen in the help display mode, the help icons being each associated with corresponding one of the functional components;
a summary description field and a detail display button displayed on a part of the normal display screen when one of the help icons is selected; and
a detailed description field displayed when the detail display button is selected.

2. The measurement control device according to claim 1, wherein the summary description field is a comment area provided at a lowermost section of the normal display screen.

3. The measurement control device according to claim 1, wherein the detail display button is displayed on a part of the summary description field.

4. The measurement control device according to claim 1, wherein the detailed description field is configured to display a description, in an on-line manual of the measurement control device, on one of the functional components associated with selected one of the help icons.

5. The measurement control device according to claim 4, wherein a manual display button configured to display a table of contents page of the on-line manual is provided at a part of the normal display screen.

6. The measurement control device according to claim 1, wherein
the normal display screen comprises a basic screen and a developed screen transitioned from or superposed on the basic screen,
the help mode button is provided at least on the basic screen, and
the help icons are each displayed on corresponding one of the functional components on the basic screen and on corresponding one of the functional components on the developed screen in the help display mode.
